(19) United States
(12) Patent Application Publication
(10) Pub. No.: US 2011/0140837 A1
(43) Pub. Date: Jun. 16, 2011

(54) UNIVERSAL SECURITY ACCESS CONTROL

(76) Inventor: Tiffany Cassandra-Do Lam, Fullerton, CA (US)

(21) Appl. No.: 13/032,021

(22) Filed: Feb. 22, 2011

(51) Int. Cl. G05B 19/00

(52) U.S. Cl. 340/5.51

(57) ABSTRACT

An embodiment is a technique for universal security access control. A panel provides user interface to a user. The panel is capable of showing a plurality of structures and receiving a user input from the user. A controller assigns access codes to the plurality of structures based on the user input and allows selection of a first structure of the plurality of structures upon a successful authentication of the user. The access codes include a first code associated with the first structure. An access storage stores the first code which is read by a reader having a preset code corresponding to the first structure. The reader activates an access mechanism of the first structure to allow entry to the first structure upon detecting a match between the first code and the preset code.

### TECHNICAL FIELD

The presently disclosed embodiments are directed to the field of security, and more specifically, to security access.

### BACKGROUND

Security has been increasingly important in our society and thefts or security breaches have been reported at an alarming rate. Personal negligence, busy activities, and thieves' increased sophistication have attributed to this trend. In addition, a typical consumer has a need to access many personal structures or devices such as house, car, rooms, safe, etc.

A typical consumer living in a modern society usually carries a large number of keys to access his or her house, car, rooms or other structures. This creates burden and inconvenience for the consumer. Furthermore, a mechanical key may be easily stolen, duplicated, or damaged. Handling a large number of keys in a normal daily life becomes more and more difficult.

### SUMMARY

One disclosed feature of the embodiments is a technique for universal security access control. A panel provides user interface to a user. The panel is capable of showing a plurality of structures and receiving a user input from the user. A controller assigns access codes to the plurality of structures based on the user input and allows selection of a first structure of the plurality of structures upon a successful authentication of the user. The access codes include a first code associated with the first structure. An access storage stores the first code which is read by a reader having a preset code corresponding to the first structure. The reader activates an access mechanism of the first structure to allow entry to the first structure upon detecting a match between the first code and the preset code.

### BRIEF DESCRIPTION OF THE DRAWINGS

Embodiments may best be understood by referring to the following description and accompanying drawings that are used to illustrate various embodiments. In the drawings.

FIG. 1 is a diagram illustrating a system for universal secured access control according to one embodiment.

FIG. 2 is a diagram illustrating a panel according to one embodiment.

FIG. 3 is a diagram illustrating a controller according to one embodiment.

FIG. 4 is a diagram illustrating modes of operation of the controller according to one embodiment.

FIG. 5 is a flowchart illustrating a process in the user security mode according to one embodiment.

FIG. 6 is a flowchart illustrating a process in the authentication mode according to one embodiment.

FIG. 7 is a flowchart illustrating a process in the assignment mode according to one embodiment.

FIG. 8 is a flowchart illustrating a process in the selection mode according to one embodiment.

FIG. 9 is a flowchart illustrating a process in the code generation mode according to one embodiment.

FIG. 10 is a diagram illustrating a system implementing the controller according to one embodiment.

### DETAILED DESCRIPTION

One disclosed feature of the embodiments is a technique for universal security access control. A panel provides user interface to a user. The panel is capable of showing a plurality of structures and receiving a user input from the user. A controller assigns access codes to the plurality of structures based on the user input and allows selection of a first structure of the plurality of structures upon a successful authentication of the user. The access codes include a first code associated with the first structure. An access storage stores the first code which is read by a reader having a preset code corresponding to the first structure. The reader activates an access mechanism of the first structure to allow entry to the first structure upon detecting a match between the first code and the preset code.

One disclosed feature of the embodiments may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc. One embodiment may be described by a schematic drawing depicting a physical structure. It is understood that the schematic drawing illustrates the basic concept and may not be scaled or depict the structure in exact proportions.

One disclosed feature of the embodiments is a method and apparatus for universal security access control. An access control device may be used as a universal secured access control device or a universal key which may obtain access to, or unlock, secured or locked structure. The device is universal because it may contain access codes for a number of secured structures. For example, the same device may be used to access a residential housing structure, a vehicle, a room, an enclosed container, etc. In this way, the user needs only to carry a single device and not a set of different keys to unlock various structures. The device is secured because it contains a user secret security code. The security code may be entered through keypad or biometric means such as fingerprint sensor or iris scanner Only a user who enters an authentication code that matches the security code may be allowed to use the device. The device is convenient and easy to use. Once successfully authenticated, the user may select the desired structure on the device and the pre-stored access code is generated to allow the user to gain access to the structure.

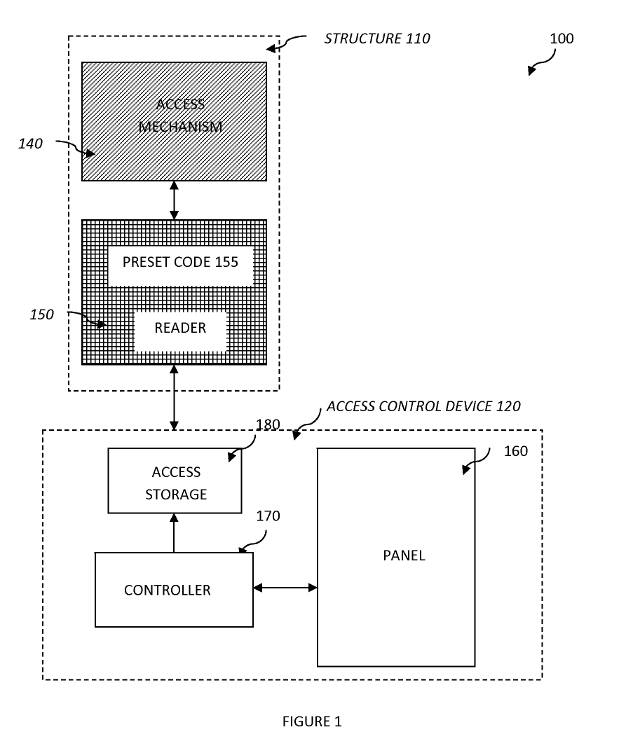

FIG. 1 is a diagram illustrating a system 100 for universal security access control according to one embodiment. The system 100 may include a structure 110 and an access control device 120.

The structure 110 is a structure that a user who uses the access control device 120 wishes to gain access or entry. The structure 110 may be any structure that has been installed with appropriate access security means. It may be a residential housing structure (e.g., a house, a dwelling, a villa, an apartment), a commercial housing structure (e.g., a building), a room, a vehicle (e.g., a car, a motorcycle, a boat), an enclosure, a container, a safe, an electronic device, a luggage, a box, a machine, a security storage, a garage, a case, a drawer, a chest, a holder, a cabinet, a closet, a compartment, a vault, an enclosed space, a cabin, or any structure or device that may require a lock and a key to unlock it.

The structure 110 may include an access mechanism 140 and a reader 150. The access mechanism 140 may be any mechanism that allows entry to the structure. It is typically designed according to the type of the structure 110. For example, if the structure 110 is a home, the access mechanism 140 may be a lock of an entrance door to the home.

The access mechanism 140 may be electronic, mechanical, electromechanical, magnetic, or electromagnetic mechanism, or any other type of mechanism that can allow entry or access to the structure. For example, it may be a relay or a solenoid valve that may be activated to release a locking lever of a lock at a door. It may be one of a door, a gate, a movable structure for opening or closing an entrance, an exit, or a passage.

The reader 150 may be coupled to the access mechanism 140 to activate the access mechanism 140 when an access is authorized. The reader 150 may activate the access mechanism 140 by generating a control signal to the access mechanism 140. An access is authorized when the reader 150 determines that an access code provided by the access control device 120 matches a preset code 155 that is stored in the reader 150. The reader 150 may have interface to allow the preset code 155 to be entered. The preset code 155 may be entered at the factory at the time of manufacture, or it may be entered by the user at the time the reader 150 is installed at the structure 110. The reader 150 may have a sensor or a scanner that senses or scans the access code as presented or provided by the access control device 120. It may be an electronic, magnetic, or optical sensor or scanner In one embodiment, the reader 150 may include a slot through which the access control device 120 is swiped across so that the access code can be read and compared with the preset code 155. In alternative embodiments, the reader 150 may be a radio frequency (RF) reader which can read information transmitted by RF from RF identification (RFID)-encoded devices.

The access control device 120 is a device that contains a number of access codes that correspond to the preset codes stored in readers at the structures. By having a large number of access codes in one device, the user can have the convenience of carrying only one device, or a single key, that can gain access or entry to a large number of structures, such as the user's house, the user's car, the user's personal box, etc. The access control device 120 may be manufactured or designed to accommodate a variety of shape and form of the readers that activate the access mechanisms at the structures. The specific shape or form depends on the type of the structure. For example, for large structure such as a house or a room, the access control device 120 may be shaped as a card like a credit card or an electronic room key card at hotels. For smaller structures such as a car, a cabinet, a safe, the access control device 120 may be shaped to have a elongated and small form having the size of a traditional key so that it can be inserted into a key slot of a reader. The access control device 120 includes a panel 160, a controller 170, and an access storage 180. The access control device 120 may include more or less than the above components. For example, the controller 170 and the access storage 180 may be combined or integrated into one component.

The access control device 120 may be implemented by low power devices and powered by rechargeable batteries or solar energy. The access control device 120 may configured or designed to have a small size that can be conveniently carried or stored in wallet, purse, or personal bag.

The panel 160 may provide user interface to a user. The interface may provide input and output. The panel 160 may be capable of showing a plurality of structures on a display and receiving a user input from the user. The panel 160 may provide the user a means to select the structure whose access mechanism is to be activated. It may also provide a means to allow the user to set up, program, initialize or configure the device to operate as a universal access control device. The panel 160 may be implemented by a number of methods. It may be implemented as a touch screen having display and soft keys or a combination of touch screen and a mechanical or electronic keypad.

The controller 170 is coupled to the panel 160 to assign access codes to the plurality of structures based on the user input and to allow selection of a desired structure of the plurality of structures upon a successful authentication of the user. The access codes may include a first code associated with the structure 110. When the structure 110 is selected from the number of structures accessible to the access control device 120 via the panel 160, a corresponding access code, the first code, is retrieved from the pre-stored access codes and is generated to the access storage 180.

The access storage 180 is coupled to the controller 170 to store the first code when the structure 110 is selected. The first code is read by the reader 150 having the preset code 115 corresponding to the structure 110. As described above, the reader 150 activates the access mechanism 140 of the structure 110 to allow entry or access to the structure 110 upon detecting a match between the first code and the preset code 155.

The access storage 180 may include one of an electronic storage, a magnetic strip, and a wireless transmitter. It may be designed to have a shape or form and/or operate like a credit card, a hotel room card, a smart card, or any shape that fits the corresponding reader of the structure. In one embodiment, the access storage 180 may include a magnetic stripe contained in a plastic-like film. The access code may be encoded in any suitable format. In alternative embodiments, the access storage 180 may be implemented by an integrated circuit (IC) chip which can transmit the access code via radio frequency in a similar manner as RFID devices. Other embodiments may include a hybrid scheme where a magnetic stripe is used in conjunction with an IC chip.

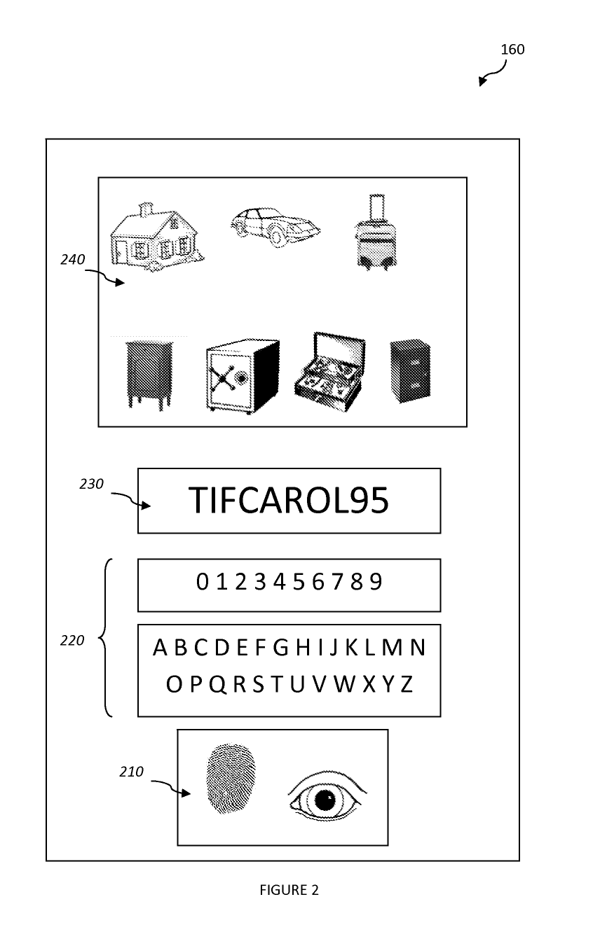

FIG. 2 is a diagram illustrating the panel 160 shown in FIG. 1 according to one embodiment. The panel 160 includes a biometric area 210, an input entry keypad 220, a display segment 230, and a graphic display 240. The panel 160 may include more or less than the above components. For example, the biometric area 210 may be optional. The biometric area 210 and the input entry keypad 220 form an inputting region. The display segment 230 and the graphic display 240 form an inputting/outputting region. As discussed above, the panel 160 may be implemented by electronic touch screen with soft keys. In this scenario, the panel 160 may function both as input and output regions.

The biometric area 210 provides biometric measurements. The biometric measurements are used to authenticate a user. When the access control device 120 is first used, initialized, programmed or configured, the user may enter his or her biometric measurements which will be used to authenticate the user in subsequent usages. Using biometric measurements provide a number of advantages. The user does not need to memorize a secret security code or a password to use the device. The information is unique to the user and cannot be guessed or compromised in case the device is stolen. The biometric area 210 may have a biometric sensor to acquire the biometric measurements. The biometric sensor may be a fingerprint sensor, an iris sensor or scanner, or any other biometric sensor. During set-up or initialization, the user enters his or her biometric measurements using the biometric area 210. For example, the user may press his or her finger on the area. He or she may position the area directly on his or her iris so that the scanner may obtain the iris information. The fingerprint sensor or the iris scanner may capture the fingerprint or the iris image and extract relevant discriminating features. These discriminating features are then stored in a storage inside the device and will be used for comparison in subsequent usage to authenticate the user.

The input entry keypad 220 includes keys corresponding to numeric or alphabets. The keys may be mechanical or electronic (e.g., soft keys via touch screen). The input entry keypad 220 may allow the user to enter his or her secret user security code, a password, which will be used to authenticate the user in subsequent usages. During set-up or initialization, the user enters his or her user security code. This user security code may be then stored in a storage inside the device and will be used for comparison in subsequent usage to authenticate the user. The user security code and the biometric measurements may be used in combination, independently, or singly. The input entry keypad 220 may also allow the user to enter the access codes associated with the structures that the device is programmed or configured to access. Typically, the access codes entered by the user match the preset codes stored in the readers of the structures such as the preset code 155 shown in FIG. 1.

The display segment 230 and the graphic display 240 provide a display to show information to the user. They may be combined into a same display or separated. The display segment 230 typically displays alphanumeric or textual information while the graphic display 240 typically displays graphical or imaging information. Both the display segment 230 and the graphic display 240 may also have both display and input entry functionalities. The display segment 230 and the graphic display 240 may be used as part of the user interface to allow the user to interact with the device. For example, they may be used to prompt the user questions, guide the user through a procedure, or help the user to navigate through the sequence of operations. As an illustrative example, the display segment 230 may display the user-entered user security code during set-up or initialization or the access codes during an assignment mode where the user assigns or programs the access codes to the structures. The graphic display 240 may display icons representing the structures (e.g., house, car, chamber, cabinet, safe, jewelry box) that are configured to be accessed by the device in a selection mode to allow the user to select the desired structure. When the graphic display 240 includes a touch screen display, the user may select the structure by pressing on the icon that shows the desired structure.

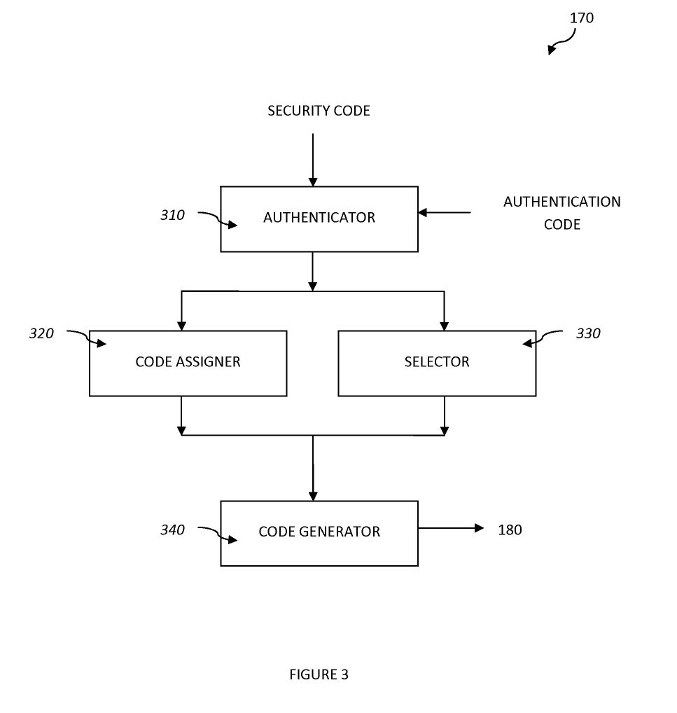

FIG. 3 is a diagram illustrating the controller 170 shown in FIG. 1 according to one embodiment. The controller 170 includes an authenticator 310, a code assigner 320, a selector 330, and a code generator 340. The controller 170 may include more or less than the above components. For example, the selector 330 and the code generator 340 may be integrated into one unit. Any of these components may be implemented by hardware, software, firmware, or any combination of them.

The authenticator 310 may store a user security code in a user security mode and to authenticate the user using the user security code and the authentication code in an authentication mode. The code assigner 320 is coupled to the authenticator 310 to assign the access codes to the plurality of the structures using the user input in the assignment mode after the user is authenticated. The selector 330 is coupled to the authenticator 310 to provide selection of the first structure in the selection mode after the user is authenticated. The code generator 310 is coupled to the code assigner 320 and the selector 330 to generate the first code to the access storage 180 (shown in FIG. 1) when the first structure (e.g., the structure 110 shown in FIG. 1) is selected.

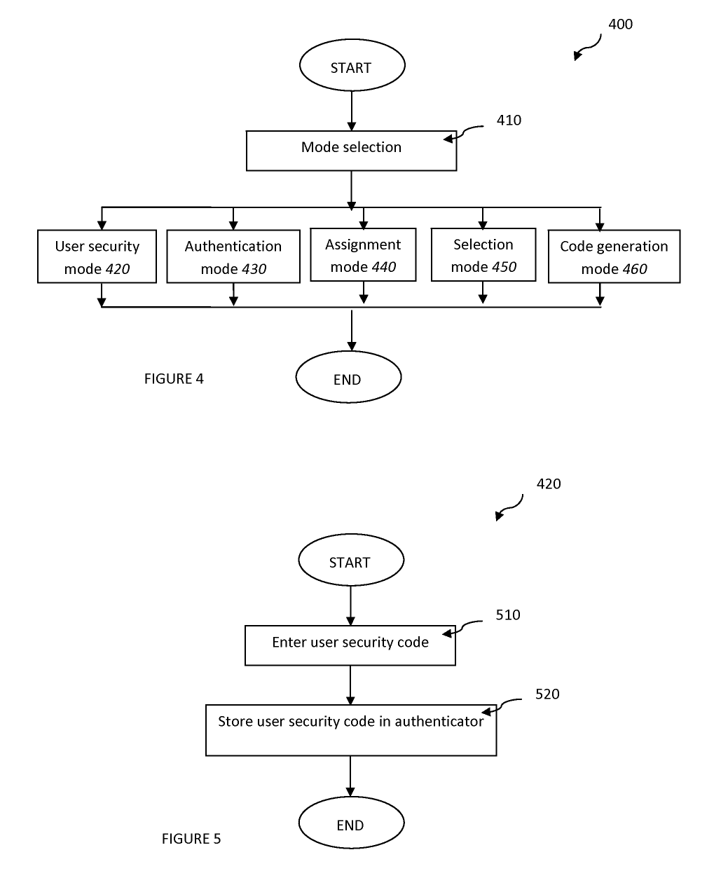

FIG. 4 is a diagram illustrating modes of operation 400 of the controller according to one embodiment. The modes of operation 400 may be selected through a mode selection module or processor element 410. For example, upon power up, the device may prompt the user to select the mode of operation by invoking the mode selection module 410. There may be five basic modes of operation: a user security mode 410, an authentication mode 430, an assignment mode 440, a selection mode 450, and a code generation mode 460. There may be more or less modes than the above modes. For example, the user security mode 410 and the authentication mode 430 may be combined into one mode.

The user security mode 410 allows the user to enter the security code. The security code may be alphanumeric, textual, or biometric as discussed above. This mode is typically invoked when the user sets up, initializes or configures the device, such as when the device is first used, or after a complete system reset which clears all information and contents.

The authentication mode 430 is invoked to authenticate the user. This mode is typically used after the user security mode 410 is completed, or when the user first enters the security code. In order for the user to be able to use the device, the user has to be authenticated by entering a correct authentication code. The correct authentication code is the code that matches the security code entered by the user in the user security mode 410. Typically, to maintain security, the authentication mode 430 may be repeated as often as necessary to guarantee that only the genuine user can access the device and to prevent the device from being misused (e.g., stolen) between usages. If a biometric measure such as the fingerprint is used, this process may be conveniently performed without much effort from the user. In this scenario, the user simply holds the device by applying the finger whose fingerprint is stored in the device and the authentication can be performed quickly.

The assignment mode 440 assigns the access codes entered by the user to the associated structures. These access codes should match the preset codes as stored in the readers corresponding to the associated structures. This mode is typically invoked at the beginning after the user security mode 410 to allow the user to assign the access codes to the individual structures. During this mode, the user is prompted to enter a structure and its corresponding access code. The number of structures and access codes is limited only by the storage capacity of the controller 170 (shown in FIG. 1). The controller 170 (FIG. 1) maintains a list of the access codes for the structures in a database or storage area.

The selection mode 450 allows the user to select the structure from a plurality of structures after the user is authenticated. This mode is typically used in two instances. The first instance is when the user enters the assignment mode 440 to assign the access codes. The second instance is when the user is ready to access a particular structure. When the graphic display 240 (FIG. 2) shows all the structures covered by the device, the user selects the desired structure by pressing a response on the panel 160. By selecting the structure from multiple available structures, the user can switch the access code accordingly at a simple key stroke. In order for the user to be able to select the structure, the user has to be authenticated in the authentication mode 430.

The code generation mode 460 generates the first code to the access storage 180 (FIG. 1) when the first structure is selected. This is done when the user has been authenticated because only after the user is authenticated the structure selection may be performed. In this mode, the controller 170 (FIG. 1) retrieves the access code corresponding to the structure selected by the user (in the selection mode 450) from the database or the table or the list of all the access codes that were stored during the assignment mode 440. The controller 170 then writes the new access code to the access storage 180 (FIG. 1) so that the new access code can be used to access the selected structure.

FIG. 5 is a flowchart illustrating a process 420 in the user security mode according to one embodiment.

Upon START, the process 420 enters the user security code (Block 510). The user security code may be entered by the user through the biometric area 210 or the keypad 220 or both. Then, the process 420 stores the user security code in the authenticator 310 (Block 520). In subsequent usages, each time the user uses the device, the user is asked to enter an authentication code which will be compared with the security code. Only when the authentication code matches the user security code then the user is authenticated. The process 420 is then terminated.

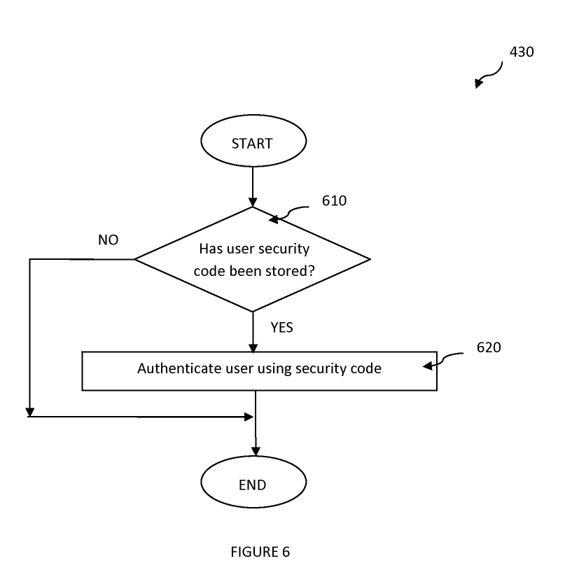

FIG. 6 is a flowchart illustrating a process 430 in the authentication mode according to one embodiment.

Upon START, the process 430 determines if a user security code has been stored (Block 610). If so, the process 430 authenticates the user using the stored user security code (Block 620) and is then terminated. The authentication may be performed by comparing the authenticate code entered by the user with the stored user security code. Only when the authentication code matches the user security code then the user is authenticated. If the authentication code does not match the user security code, the user is not authenticated and the device cannot be used. If the user security code has not been stored, the process 430 is terminated and the user is not authenticated.

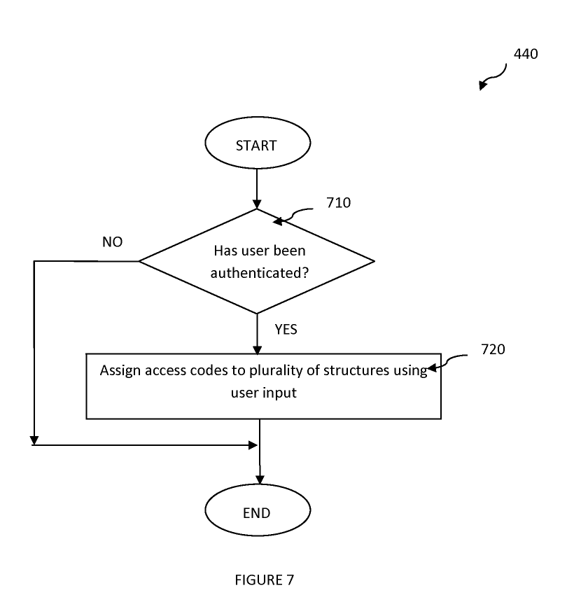

FIG. 7 is a flowchart illustrating a process 440 in the assignment mode according to one embodiment.

Upon START, the process 440 determines if the user has been authenticated (Block 710). If not, the process 440 is terminated and the user cannot operate the assignment mode. Otherwise, the process 440 assigns access codes to the plurality of structures using the user input (Block 720) and is then terminated. To facilitate the entry of the access codes, standard portions of the access codes may be pre-stored and the user needs only to enter the distinguishing portion of the code.

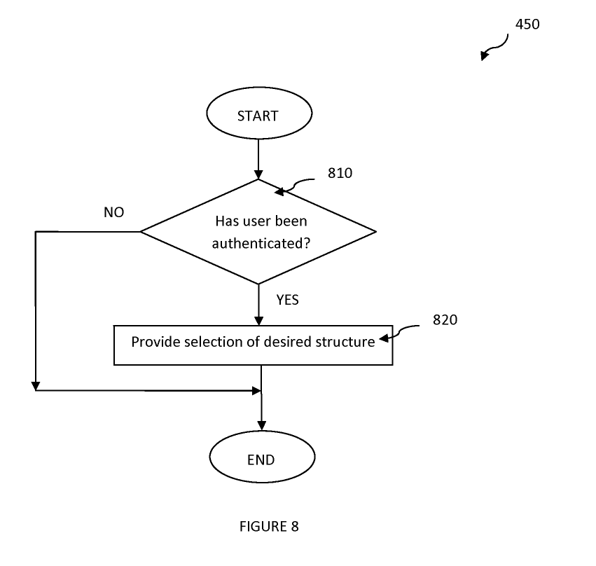

FIG. 8 is a flowchart illustrating a process 450 in the selection mode according to one embodiment.

Upon START, the process 450 determines if the user has been authenticated (Block 810). If not, the process 450 is terminated and the user cannot operate the selection mode. Otherwise, the process 450 provides selection of the desired structure (Block 820) and is then terminated. This may be performed by displaying all the available structures on the graphic display area. The user simply presses on the icon representing the selected structure. Alternatively, the user may enter a code representing the desired structure.

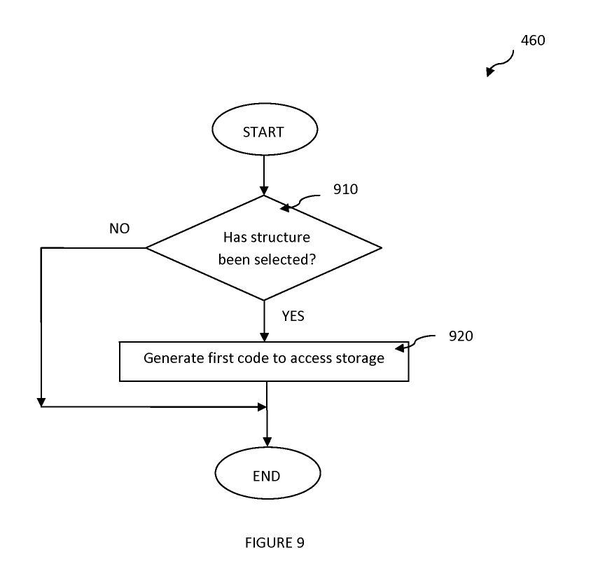

FIG. 9 is a flowchart illustrating a process 460 in the code generation mode according to one embodiment.

Upon START, the process 460 determines if a structure has been selected (Block 910). If not, the process 460 is terminated and the code generation mode cannot proceed. Otherwise, the process 460 generates the access code corresponding to the selected structure to the access storage (Block 920) and is then terminated.

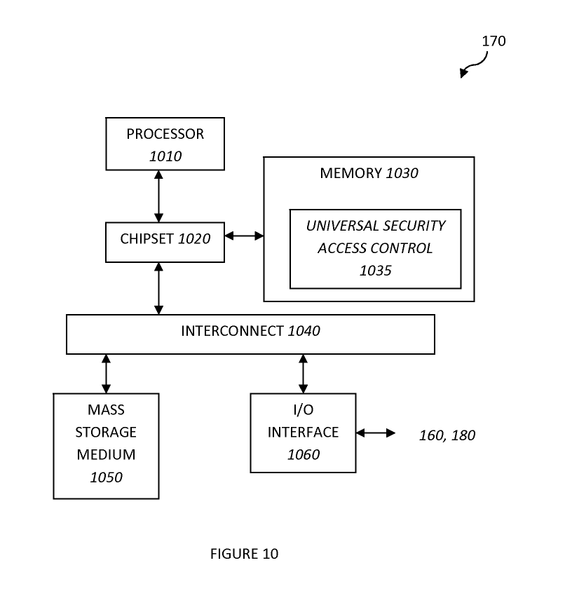

FIG. 10 is a diagram illustrating a system 170 implementing the controller according to one embodiment. The controller 170 includes a processor 1010, a chipset 1020, a memory 1030, an interconnect 1040, a mass storage medium 1050, an input/output (I/O) interface 1060. The controller 170 may include more or less of the above components.

The processor 1010 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The chipset 1020 provides control and configuration of memory and input/output devices such as the memory 1030, the mass storage medium 1050 and the I/O interface 1060. The chipset 1020 may integrate multiple functionalities such as graphics, media, host-to-peripheral bus interface, memory control, power management, etc. It may also include a number of interface and I/O functions such as peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, wireless interconnect, direct media interface (DMI), etc.

The memory 1030 stores code and data. The memory 1030 is typically implemented with dynamic random access memory (DRAM), static random access memory (SRAM), or any other types of memories including those that do not need to be refreshed. The memory 1030 may include a universal security access control module 1035 that performs all or portion of the operations described above.

The interconnect 1040 provides interface to peripheral devices. The interconnect 1040 may be point-to-point or connected to multiple devices. For clarity, not all interconnects are shown. It is contemplated that the interconnect 1040 may include any interconnect or bus such as Peripheral Component Interconnect (PCI), PCI Express, Universal Serial Bus (USB), Small Computer System Interface (SCSI), serial SCSI, and Direct Media Interface (DMI), etc.

The mass storage medium 1050 includes interfaces to mass storage devices to store archive information such as code, programs, files, data, and applications. The mass storage interface may include SCSI, serial SCSI, Advanced Technology Attachment (ATA) (parallel and/or serial), Integrated Drive Electronics (IDE), enhanced IDE, ATA Packet Interface (ATAPI), etc. The mass storage device may include compact disk (CD) read-only memory (ROM) 852, digital video/versatile disc (DVD) 853, floppy drive 854, hard drive 855, tape drive 856, and any other magnetic or optic storage devices. The mass storage device provides a mechanism to read machine-accessible media. In one embodiment, the mass storage medium 1050 may include flash memory.

The I/O interface 1060 provides interface to I/O devices such as the panel 160 or the access storage 180. The I/O interface 1060 may provide interface to a touch screen in the panel 160, a magnetic strip or a smart card IC located in the access storage 180.

Elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any electronic devices. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EPROM). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations. The program or code segments may be stored in a processor or machine accessible medium. The “processor readable or accessible medium” or “machine readable or accessible medium” may include any medium that may store or transfer information. Examples of the processor readable or machine accessible storage medium include an electronic circuit, a semiconductor memory device, a read only memory (ROM), a flash memory, an erasable programmable ROM (EPROM), a floppy diskette, a compact disk (CD) ROM, an optical disk, a hard disk, etc. The machine accessible storage medium may be embodied in an article of manufacture. The machine accessible storage medium may include information or data that, when accessed by a machine, cause the machine to perform the operations or actions described above. The machine accessible storage medium may also include program code, instruction or instructions embedded therein. The program code may include machine readable code, instruction or instructions to perform the operations or actions described above. The term “information” or “data” here refers to any type of information that is encoded for machine-readable purposes. Therefore, it may include program, code, data, file, etc.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An apparatus comprising:
a panel to provide user interface to a user, the panel capable of showing a plurality of structures and receiving a user input from the user;
a controller coupled to the panel to assign access codes to the plurality of structures based on the user input and to allow selection of a first structure of the plurality of structures upon a successful authentication of the user, the access codes including a first code associated with the first structure; and
an access storage coupled to the controller to store the first code, the first code being read by a reader having a preset code corresponding to the first structure, the reader activating an access mechanism of the first structure to allow entry to the first structure upon detecting a match between the first code and the preset code.

2. The apparatus of claim 1 wherein the panel comprises:
a graphic display to display the plurality of structures; and
an input interface to receive the user input.

3. The apparatus of claim 2 wherein the input interface receives the user input including an authentication code, the access codes, the selection of the one of the plurality of structures.

4. The apparatus of claim 1 wherein the controller operates in one of a user security mode, an authentication mode, an assignment mode, and a selection mode.

5. The apparatus of claim 4 wherein the controller comprises:
an authenticator to store a user security code in the user security mode and to authenticate the user using the user security code and the authentication code in the authentication mode;
a code assigner coupled to the authenticator to assign the access codes to the plurality of the structures using the user input in the assignment mode after the user is authenticated;
a selector coupled to the authenticator to provide selection of the first structure in the selection mode after the user is authenticated; and
a code generator coupled to the selector to generate the first code to the access storage when the first structure is selected.

6. The apparatus of claim 1 wherein the access storage comprises one of an electronic storage, a magnetic strip, and a wireless transmitter.

7. The apparatus of claim 1 wherein the panel comprised a touch screen display.

8. The apparatus of claim 3 wherein the authenticate code comprises one of a sequence of symbols and a biometric measurement.

9. The apparatus of claim 2 wherein the user interface comprises one of a keypad entry and a biometric sensor.

10. The apparatus of claim 1 wherein the plurality of structures includes one of a residential housing structure, a commercial housing structure, a room, a vehicle, an enclosure, a container, a safe, an electronic device, a luggage, a box, a machine, a security storage, a garage, a case, a drawer, a chest, a holder, a cabinet, a closet, a compartment, a vault, an enclosed space, and a cabin.

11. The apparatus of claim 1 wherein the access mechanism includes one of a door, a gate, a movable structure for opening or closing an entrance, an exit, or a passage.

12. A method comprising:
providing user interface to a user using a panel, the panel capable of showing a plurality of structures and receiving a user input from the user;
controlling assigning access codes to the plurality of structures based on the user input and allowing selection of a first structure of the plurality of structures upon a successful authentication of the user, the access codes including a first code associated with the first structure; and
storing the first code, the first code being read by a reader having a preset code corresponding to the first structure, the reader activating an access mechanism of the first structure to allow entry to the first structure upon detecting a match between the first code and the preset code.

13. The method of claim 12 wherein providing user interface comprises:
displaying the plurality of structures; and
receiving the user input.

14. The method of claim 13 wherein receiving the user input comprises receiving the user input including an authentication code, the access codes, the selection of the one of the plurality of structures.

15. The method of claim 12 wherein controlling comprises operating in one of a user security mode, an authentication mode, an assignment mode, and a selection mode.

16. The method of claim 15 wherein controlling comprises:
storing a user security code in the user security mode and authenticating the user using the user security code and the authentication code in the authentication mode;
assigning the access codes to the plurality of the structures using the user input in the assignment mode after the user is authenticated;
providing selection of the first structure in the selection mode after the user is authenticated; and
generating the first code to the access storage when the first structure is selected.

17. The method of claim 12 wherein storing the first code comprises storing the first code in one of an electronic storage, a magnetic strip, and a wireless transmitter.

18. A system comprising:
a first structure having an access mechanism to allow entry to the structure and a reader coupled to the access mechanism to activate the access mechanism when an access is authorized; and
an access control device, the access control device comprising:
a panel to provide user interface to a user, the panel capable of showing a plurality of structures and receiving a user input from the user,
a controller coupled to the panel to assign access codes to the plurality of structures based on the user input and to allow selection of the first structure of the plurality of structures upon a successful authentication of the user, the access codes including a first code associated with the first structure, and
an access storage coupled to the controller to store the first code, the first code being read by a reader having a preset code corresponding to the first structure, the reader activating an access mechanism of the first structure to allow entry to the first structure upon detecting a match between the first code and the preset code.

19. The system of claim 18 wherein the controller operates in one of a user security mode, an authentication mode, an assignment mode, and a selection mode.

20. The system of claim 19 wherein the controller comprises:
an authenticator to store a user security code in the user security mode and to authenticate the user using the user security code and the authentication code in the authentication mode;
a code assigner coupled to the authenticator to assign the access codes to the plurality of the structures using the user input in the assignment mode after the user is authenticated;
a selector coupled to the authenticator to provide selection of the first structure in the selection mode after the user is authenticated; and
a code generator coupled to the selector to generate the first code to the access storage when the first structure is selected.
